(19) United States
(12) Patent Application Publication
(10) Pub. No.: US 2013/0033103 A1
(43) Pub. Date: Feb. 7, 2013

(54) Systems and Methods For Distributed Impedance Compensation In Subsea Power Distribution

(71) Applicants: Samuel T. McJunkin, Houston, TX (US); John S. Wheat, Tomball, TX (US)

(72) Inventors: Samuel T. McJunkin, Houston, TX (US); John S. Wheat, Tomball, TX (US)

(21) Appl. No.: 13/558,013

(22) Filed: Jul. 25, 2012

Related U.S. Application Data
(60) Provisional application No. 61/514,346, filed on Aug. 2, 2011.

(51) Int. Cl. H02J 3/00; G05B 6/02; H01B 9/00

(52) U.S. Cl. 307/11; 307/147; 307/98; 307/109

(57) ABSTRACT

Systems and methods for impedance compensation in a subsea power distribution system. These systems and methods include the use of a plurality of distributed impedance compensation devices to control the impedance of the subsea power distribution system. These systems and methods may include the use of distributed impedance compensation devices that are inductively coupled to a subsea power transmission cable associated with the subsea power distribution system. These systems and methods also may include the use of distributed impedance compensation devices that are inductively powered by the subsea power transmission cable. These systems and methods further may include the use of distributed impedance compensation devices that are marinised for use under water.

### CROSS-REFERENCE TO RELATED APPLICATIONS

This application claims the benefit of U.S. provisional patent application No. 61/514,346 filed on Aug. 2, 2011 entitled SYSTEMS AND METHODS FOR DISTRIBUTED IMPEDANCE COMPENSATION IN SUBSEA POWER DISTRIBUTION, the entirety of which is incorporated herein.

### FIELD OF THE DISCLOSURE

The present disclosure is directed to systems and methods for controlling the impedance of a subsea power distribution system, and more particularly to systems and methods that utilize a plurality of distributed impedance compensation devices to control the impedance of a subsea power distribution system.

### BACKGROUND OF THE DISCLOSURE

As the oil and gas industry discovers and develops deeper and more remote subsea hydrocarbon reserves, subsea tiebacks that may supply recovered hydrocarbons to production facilities economically and over longer distances become increasingly important. These long-distance subsea tiebacks may utilize subsea pressure boosting equipment, such as pumps and/or compressors powered by electric motors, to provide a motive force for flow of the recovered hydrocarbons through the subsea tieback. However, controlling the production and supply of electrical energy to these electric motors over long distances and in a subsea environment presents technological challenges.

Electrical power generation and distribution systems often are designed to produce and distribute electricity over a range of power levels. They are typically load-following systems that may increase electrical power generation when a demand for electrical power increases and/or decrease electrical power generation when the demand for electrical power decreases, thereby striving to match power generation with power consumption. This matching may be accomplished by changing the electrical power output from the power generation system to accommodate long-term changes in power consumption, as well as through the use of energy storage devices, such as inductors and/or capacitors, to accommodate short-term changes in power consumption and/or power transients.

In electrical power generation and distribution systems that utilize alternating current (AC) electrical power, the apparent power supplied by the power generation system is composed of real power and reactive power components. “Real power” refers to supplied electrical power that is available to do work at an attached electrical load due to the voltage and current being in-phase. In contrast, “reactive power” is supplied electrical power that does not do work at the attached electrical load due to the voltage and current being 90 degrees out-of-phase. While necessary for use as energy storage devices, inductive and/or capacitive loads present within the electrical power generation and distribution system also contribute to the presence of reactive power within the system. “Apparent power” refers to the root-mean-square of the voltage and current carried by the power distribution system and includes both real power and reactive power components.

While reactive power is not available to do work at the attached electrical load, it still must be generated by the power generation system. Thus, its presence decreases the overall efficiency of the power distribution system. In addition, since reactive power contributes to the overall, or total, electrical power transmitted by the power distribution system, the components of the power distribution system must be sized to accommodate an expected range of both real and reactive power transmitted therethrough, thereby increasing the overall size and costs of the power distribution system. The magnitude of the reactive power present within the system may be controlled by changing the electrical impedance of the system. Therefore, it may be desirable to control the electrical impedance of the power distribution system in order to maintain the reactive power below a threshold level. This may be accomplished by selectively applying impedance compensation devices, such as capacitive and/or inductive loads, to the power distribution system.

For electrical utilities that operate large-scale power generation and distribution systems that are located primarily on land, management of the power generation and distribution system to ensure a balance between generated electrical power and consumed electrical power may be accomplished by scheduling the power demands of larger users, by ensuring that the power consumption of the majority of individual users is only a small percentage of the overall power consumption so that changes in the power consumption of the individual user only have a small impact on the overall power consumption within the power generation and distribution system, and/or through the use of large-scale energy storage devices, which are typically located at power substations and may be selectively applied to the power delivery system. In addition, managing the impedance of a land-based power distribution system to control reactive power transmission may be accomplished through the use of large-scale impedance compensation devices, which are typically located at power substations and may be selectively applied to the power delivery system to maintain reactive power below the threshold level despite power transients within the system.

The transmission of electrical power over long distances in a subsea environment poses unique challenges associated with system installation, system maintenance, equipment marinisation, power demand scheduling, and/or overall control of the subsea power distribution network. These challenges may be attributed to a variety of factors, including difficulties associated with accessing equipment located in the subsea environment, difficulties associated with monitoring equipment located in the subsea environment, difficulties associated with controlling equipment located in the subsea environment, the harsh environmental conditions present within the subsea environment, the length of the power transmission lines within the power distribution network, and/or the fact that the electrical output capacity of the power generation equipment may be comparable to the power consumption of the individual loads that are attached thereto. Thus, load transients associated with changing the state of a single electrical load may have a significant impact on the overall electrical load placed on the power generation system and/or carried by the power distribution system.

In addition, the large-scale energy storage and impedance compensation equipment utilized with land-based power generation and distribution systems may not be designed to and/or be capable of operating in the subsea environment, and marinisation of these large-scale devices may be challenging for a variety of reasons. As an illustrative example, the large-scale, land-based devices are typically placed in close proximity to the electrical load and/or the electricity source and cannot manage the reactive power present within other portions of the power distribution system. As another illustrative example, the physical size of these large-scale devices may preclude their use in the subsea environment. As yet another illustrative example, these large-scale devices typically require off-site monitoring and control, which may not be feasible in the subsea environment. As yet another illustrative example, transmission of electrical current in land-based systems is typically accomplished using overhead wiring that provides for large separation distances between the individual phases of the AC current. In contrast, in subsea applications, all phases of the wiring are typically bundled together, thereby increasing the capacitive load within the cabling itself and decreasing the distance over which the electrical power may be transferred without the need for impedance compensation.

### SUMMARY OF THE DISCLOSURE

Systems and methods for impedance compensation in a subsea power distribution system. These systems and methods include the use of a plurality of distributed impedance compensation devices to control the impedance of the subsea power distribution system. These systems and methods also may include the use of distributed impedance compensation devices that are inductively powered by the subsea power transmission cable, the use of distributed impedance compensation devices that are inductively coupled to a subsea power transmission cable associated with the subsea power distribution system, and/or the use of distributed impedance compensation devices that are marinised and configured for use under water. The subsea power distribution system may be configured to provide electrical energy to subsea hydrocarbon recovery equipment.

In some embodiments, at least a portion of the plurality of distributed impedance compensation devices may include a controller that is configured to control the operation of one or more of the distributed impedance compensation devices. In some embodiments, at least a portion of the plurality of distributed impedance compensation devices may include a detector that is configured to detect a variable associated with the subsea power distribution system. In some embodiments, the controller may control the operation of the one or more distributed impedance compensation devices based at least in part on the value of the variable associated with the subsea power distribution system.

In some embodiments, at least a portion of the plurality of distributed impedance compensation devices may include one or more power compensation elements. In some embodiments, the one or more power compensation elements may include a passive electrical component. In some embodiments, the passive electrical component may include a resistor, a capacitor, and/or an inductor. In some embodiments, at least a portion of the plurality of distributed impedance compensation devices also may include a switching device. In some embodiments, the switching device may be configured to selectively establish electrical communication between the power compensation element and the subsea power transmission cable. In some embodiments, the switching device may be controlled by the controller.

### BRIEF DESCRIPTION OF THE DRAWINGS

FIG. 1 is a schematic representation of an illustrative, non-exclusive example of a subsea power distribution system according to the present disclosure.

FIG. 2 is a schematic representation of an illustrative, non-exclusive example of a portion of a subsea power transmission line according to the present disclosure.

FIG. 3 is a schematic representation of another illustrative, non-exclusive example of a portion of a subsea power transmission line according to the present disclosure.

FIG. 4 is a schematic representation of another illustrative, non-exclusive example of a subsea power distribution system according to the present disclosure.

FIG. 5 is a schematic representation of another illustrative, non-exclusive example of a subsea power distribution system according to the present disclosure.

FIG. 6 is a flowchart depicting illustrative, non-exclusive examples of methods of controlling the impedance of a subsea power distribution system according to the present disclosure.

### DETAILED DESCRIPTION AND BEST MODE OF THE DISCLOSURE

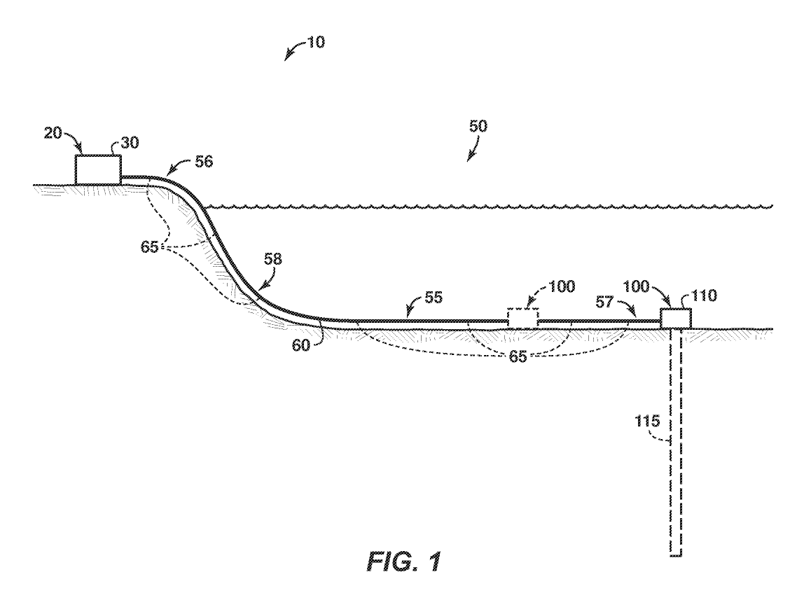

FIG. 1 provides a schematic representation of an illustrative, non-exclusive example of a power generating and distributing assembly 10 according to the present disclosure. Power generating and distributing assembly 10 includes any suitable electricity source 20, such as power generation system 30, as well as subsea power distribution system 50. Subsea power distribution system 50 provides electrical energy from electricity source 20 to one or more subsea energy consuming devices 100, such as subsea hydrocarbon recovery equipment 110.

Electricity source 20 may include any suitable source of electrical energy, or electrical potential, including sources of high voltage alternating current (HVAC). Illustrative, non-exclusive examples of sources of electrical energy according to the present disclosure include any suitable type and number of electrical utility grid, energy storage device, battery, capacitor, inductor, and/or power generation system 30. Power generation system 30 may include any suitable system configured to generate electrical energy. Illustrative, non-exclusive examples of power generation systems 30 according to the present disclosure include generators, photovoltaic cells, fuel cells, and/or turbines.

Subsea power distribution system 50 is configured to conduct electrical current from electricity source 20 to subsea energy consuming device(s) 100. Subsea power distribution systems 50 according to the present disclosure include a subsea power transmission line 55 that includes a subsea power transmission cable 60 and a plurality of distributed impedance compensation devices 65.

Subsea power transmission cable 60 includes any suitable cable configured to transmit electrical current. As an illustrative, non-exclusive example, subsea power transmission cable 60 may include a three-phase alternating current (AC) subsea power transmission cable. It is within the scope of the present disclosure that the three phase alternating current subsea power transmission cable may include at least three electrical conductors. It is also within the scope of the present disclosure that each of the at least three electrical conductors may be electrically isolated from the other of the at least three electrical conductors. As an illustrative, non-exclusive example, at least a portion of the at least three electrical conductors may include an insulating sheath.

It is also within the scope of the present disclosure that at least a portion of the at least three electrical conductors may be bundled together along at least a portion of, and optionally a majority portion or all of, a length of the subsea power transmission line. Additionally or alternatively, it is also within the scope of the present disclosure that all of the at least three electrical conductors may be bundled together along at least the portion of, and optionally a majority portion or all of, the length of the subsea power transmission line.

It is within the scope of the present disclosure that subsea power transmission line 55 may include any suitable length. As an illustrative, non-exclusive example, the subsea power transmission line may be at least 100 kilometers (km) in length, including subsea power transmission lines that are at least 200 km in length, at least 300 km in length, at least 400 km in length, at least 500 km in length, at least 750 km in length, at least 1000 km in length, at least 1250 km in length, at least 1500 km in length, at least 2000 km in length, at least 2500 km in length, at least 3000 km in length, at least 4000 km in length, or at least 5000 km in length. It is also within the scope of the present disclosure that the length of the subsea power transmission line additionally or alternatively may be referred to as a distance between components of power generating and distributing assembly 10, such as a distance between any two of electricity source 20, power generation system 30, impedance compensation devices 65, subsea energy consuming device 100, and/or subsea hydrocarbon recovery equipment 110.

It is within the scope of the present disclosure that any suitable portion, such as a majority or other substantial portion, or even all, of the length of the subsea power transmission line may be located under water. As an illustrative, non-exclusive example, at least 50%, at least 60%, at least 70%, at least 80%, at least 90%, at least 95%, at least 99%, at least 99.5%, or at least 99.9% of the length of the subsea power transmission line may be located under water. Accordingly, subsea power transmission line 55 may be referred to as a marinised and/or submarine power transmission line.

The plurality of distributed impedance compensation devices 65 may include impedance compensation devices that may be electrically coupled to the subsea power transmission cable and may be powered by, may selectively interact with, and/or may selectively modify the impedance of the subsea power transmission line. As an illustrative, non-exclusive example, at least a portion of the plurality of distributed impedance compensation devices may be electrically coupled to the subsea power transmission cable through an inductive coupling. It is within the scope of the present disclosure that this inductive coupling may provide electrical power from the subsea power transmission cable to the portion of the plurality of distributed impedance compensation devices and/or may provide information about the operation of the subsea power distribution system to the portion of the plurality of distributed impedance compensation devices. It is also within the scope of the present disclosure that the portion of the plurality of distributed impedance compensation devices may utilize this inductive coupling to regulate, adjust, and/or modify the impedance of the subsea power transmission line.

It is within the scope of the present disclosure that at least a portion of the plurality of distributed impedance compensation devices may be inductively coupled to one of the at least three conductors, two of the at least three conductors, or all three of the at least three conductors of the subsea power transmission cable. It is also within the scope of the present disclosure that at least a portion of the plurality of distributed impedance compensation devices may include a controller configured to control the operation of one or more of the plurality of distributed impedance compensation devices. It is further within the scope of the present disclosure that at least a portion of the plurality of distributed impedance compensation devices may include marinised impedance compensation devices that are configured for use under water.

The plurality of distributed impedance compensation devices may be placed at any suitable location within subsea power distribution system 50 and/or at any suitable location along the length of subsea power transmission cable 60. As shown in FIG. 1, subsea power transmission line 55 includes at least a power supply region 56, which may be associated with and/or proximal to electricity source 20, a power delivery region 57, which may be associated with and/or proximal to subsea energy consuming device 100, and a power transfer region 58, which may extend between the power supply region and the power delivery region. It is within the scope of the present disclosure that at least a portion of the plurality of distributed impedance compensation devices may be located in at least one of the power supply region, the power delivery region, and/or the power transfer region.

It is also within the scope of the present disclosure that at least a portion of the plurality of distributed impedance compensation devices may be distributed, placed, or otherwise spread along the length of the subsea power transmission line. This may include distributed impedance compensation devices that are located periodically along the length of the subsea power transmission line, such as when the spacing between adjacent impedance compensation devices is approximately constant, and/or systematically along the length of the subsea power transmission line, such as when the impedance compensation devices are placed at defined, specified, and/or calculated locations along the length of the subsea power transmission line. As an illustrative, non-exclusive example, a location for at least a portion of the plurality of distributed impedance compensation devices within the subsea power distribution system and/or along the subsea power transmission line may be selected based at least in part on a power of the electrical energy transmitted by the subsea power transmission line, a frequency of the electrical energy transmitted by the subsea power transmission line, a voltage of the electrical energy transmitted by the subsea power transmission line, a current of the electrical energy transmitted by the subsea power transmission line, an electrical impedance of the subsea power transmission line, an electrical impedance of an electricity source associated with the subsea power transmission line, an electrical impedance of an energy consuming device associated with the subsea power transmission line, a length of the subsea power transmission line, and/or a variable associated with the plurality of distributed impedance compensation devices.

Each of the plurality of distributed impedance compensation devices may be incorporated into subsea power transmission line 55 in any suitable manner. As an illustrative, non-exclusive example, it is within the scope of the present disclosure that at least a portion of the plurality of distributed impedance compensation devices may be operatively attached to the subsea power transmission cable, such as by being clamped to, wrapped around, adhered to, fastened to, and/or otherwise affixed to the subsea power transmission cable and/or to an exterior surface thereof. When an impedance compensation device 65 is operatively attached to the subsea power transmission cable, it is within the scope of the present disclosure that the impedance compensation device may be configured to be permanently attached to the subsea power transmission cable. However, it is also within the scope of the present disclosure that the impedance compensation device may be configured to be removably attached to the subsea power transmission cable (i.e., removed and optionally replaced without destruction of or damage to the impedance compensation device and/or the subsea power transmission cable). As another illustrative, non-exclusive example, it is also within the scope of the present disclosure that at least a portion of the plurality of distributed impedance compensation devices may form a part of subsea power transmission line 55, such as by being incorporated into, formed with, and/or being internal to the subsea power transmission line.

Subsea energy consuming device 100 may include any suitable device that is marinised, or configured for use in a subsea environment, and that may function as an electrical load and/or may consume electrical energy in order to perform a desired operation.

As an illustrative, non-exclusive example, subsea energy consuming device 100 may include any suitable electric motor, HVAC electric motor, three-phase alternating current electric motor, heater, controller, detector, sensor, valve, and/or flow meter. When subsea energy consuming device 100 includes one or more electric motors, these electric motors may be utilized to power any suitable device, illustrative, non-exclusive examples of which may include any suitable compressor, blower, and/or pump.

It is within the scope of the present disclosure that subsea energy consuming device 100 also may include subsea hydrocarbon recovery equipment 110. As an illustrative, non-exclusive example, this may include any suitable subsea oil pump, subsea oil pressure booster pump, subsea natural gas compressor, subsea oil well monitoring equipment, and/or subsea oil pipeline heating equipment. It is also within the scope of the present disclosure that subsea energy consuming device 100 and/or subsea hydrocarbon recovery equipment 110 may be associated with a subsea hydrocarbon well 115.

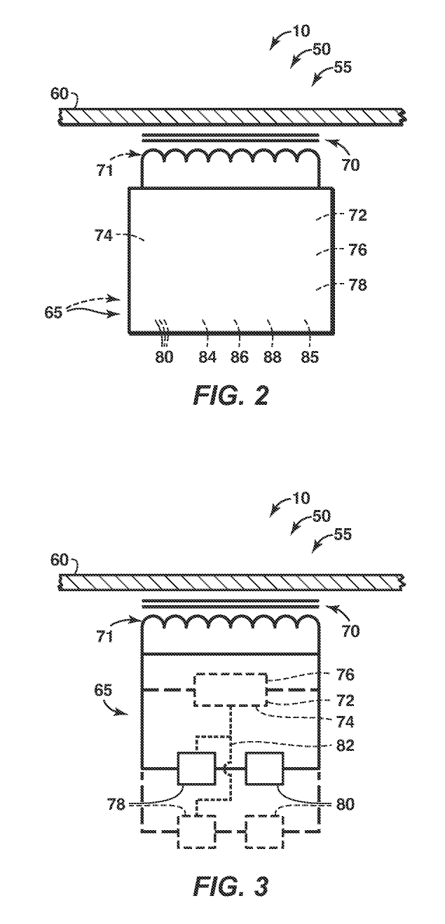

FIG. 2 provides a schematic representation of an illustrative, non-exclusive example of a portion of subsea power transmission line 55 according to the present disclosure. As discussed in more detail herein, the subsea power transmission line includes subsea power transmission cable 60 and a plurality of distributed impedance compensation devices 65, only one of which is shown in FIG. 2. As also discussed in more detail herein, an inductive coupling interface 70, which may include a coupling inductor 71, may provide electrical communication between power transmission cable 60 and impedance compensation device 65.

It is within the scope of the present disclosure that impedance compensation device 65 may include a plurality of electrical components that are configured to provide power to the impedance compensation device, control the operation of the impedance compensation device, detect a status of the impedance compensation device, detect a status of subsea power transmission line 55, and/or control the impedance of subsea power transmission line 55. As an illustrative, non-exclusive example, impedance compensation device 65 may include one or more controller 72, detector 74, power supply 76, switching device 78, and/or impedance compensation element 80.

Controller 72 may include any suitable controller configured to control the operation of at least one of impedance compensation device 65, subsea power transmission line 55, and/or subsea power distribution system 50. It is within the scope of the present disclosure that subsea power transmission line 55 may include one or more controllers that are configured to control the operation of more than one impedance compensation device 65, as well as impedance compensation devices that include built-in, dedicated controllers. As an illustrative, non-exclusive example, a first impedance compensation device 65 may include a first controller 72 and first controller 72 may control the operation of the first impedance compensation device. As another illustrative, non-exclusive example, a second controller 72 that is associated with a second impedance compensation device may control the operation of two, multiple, or even all of the plurality of distributed impedance compensation devices.

It is within the scope of the present disclosure that, as shown in FIG. 2, controller 72 may be integrated into and/or form a portion of impedance compensation device 65. However, it is also within the scope of the present disclosure that controller 72 may be separate from, but in communication with, one or more impedance compensation devices.

Power supply 76 may provide electrical power to at least a portion of impedance compensation device 65, such as to controller 72. It is within the scope of the present disclosure that power supply 76 may receive electrical energy through inductive coupling 70 and/or be inductively powered by subsea power transmission cable 60. When power supply 76 receives electrical energy through inductive coupling 70 from power transmission cable 60 and provides electrical power to controller 72, controller 72 may be referred to as an inductively powered controller 72. It is within the scope of the present disclosure that power supply 76 may include an alternating current to direct current (AC-DC) converter.

Detector 74 may be configured to detect an electrical parameter of subsea power transmission line 55 and/or power generating and distributing assembly 10. As an illustrative, non-exclusive example, detector 74 may detect an electrical parameter associated with at least one conductor of subsea power transmission cable 60. It is within the scope of the present disclosure that the electrical parameter may include any suitable electrical parameter, illustrative, non-exclusive examples of which include any suitable voltage, electrical current, electrical power, electrical impedance, reactive power, real power, and/or apparent power associated with one or more of the subsea power transmission line and/or the power generating and distributing assembly.

Switching device 78 may be configured, such as by controller 72, to selectively establish electrical communication, such as through inductive coupling interface 70, between one or more impedance compensation element 80 and subsea power transmission cable 60 to control the impedance of subsea power transmission line 55 responsive to the value of the electrical parameter. It is within the scope of the present disclosure that switching device 78 may include any suitable structure. As an illustrative, non-exclusive example, switching device 78 may include at least one of a solid state switch, a transistor, an insulated gate bipolar transistor, a thyristor, a gate turn off thyristor, an integrated gate commutated thyristor, a metal oxide semiconductor field effect transistor, and/or a silicon controlled rectifier. It is also within the scope of the present disclosure that switching device 78 may include at least an open state, in which electrical current may not flow therethrough, and a closed state, in which electrical current may flow therethrough.

Impedance compensation element 80 may include any suitable structure that is configured to control, or modify, the impedance of subsea power transmission line 55. Illustrative, non-exclusive examples of impedance compensation elements 80 according to the present disclosure include any suitable passive electrical component, including any suitable resistor 84, diode 85, capacitor 86, and/or inductor 88. It is within the scope of the present disclosure that impedance compensation devices 65 according to the present disclosure may include any suitable number of impedance compensation elements 80, including one, two, three, four, five, six, seven, eight, nine, ten, more than ten impedance compensation elements, or a plurality of impedance compensation elements.

It is within the scope of the present disclosure that controller 72 may be configured to selectively control the electrical impedance of subsea power transmission line 55 by the controlling the operation of impedance compensation device 65. This may include controlling the resistance, inductance, and/or capacitance of the subsea power transmission line.

It is also within the scope of the present disclosure that controller 72 may be configured to control the impedance of subsea power transmission line 55 automatically. As an illustrative, non-exclusive example, controller 72 may control the impedance of subsea power transmission line 55 based upon the value of the electrical parameter that is detected by detector 74. As another illustrative, non-exclusive example, controller 72 may be configured to increase the capacitance of the subsea power transmission line responsive to an increase in the electrical current conducted by the subsea power transmission line. As another illustrative, non-exclusive example, controller 72 may be configured to decrease the capacitance of the subsea power transmission line responsive to a decrease in the electrical current conducted by the subsea power transmission line. As yet another illustrative, non-exclusive example, controller 72 may be configured to increase the inductance of the subsea power transmission line responsive to an increase in the capacitance of the subsea power transmission line and/or decrease the inductance of the subsea power transmission line responsive to a decrease in the capacitance of the subsea power transmission line. As another illustrative, non-exclusive example, controller 72 may be configured to protect electrical equipment associated with subsea power distribution system 50 and/or power generating and distributing assembly 10 from short circuits.

It is within the scope of the present disclosure that controller 72 may be configured to adjust, change, or otherwise modify a natural frequency of the subsea power transmission line through the use of impedance compensation devices 65. As an illustrative, non-exclusive example, and when subsea power distribution system 60 includes one or more inductance and one or more capacitance in parallel, controller 72 may be configured to adjust the natural frequency of the subsea power transmission line away from a supply frequency for the alternating current (AC) electrical current that is conducted by the subsea power transmission line to decrease electrical losses within the subsea power distribution system. As another illustrative, non-exclusive example, and when subsea power distribution system 60 includes one or more inductance and one or more capacitance in series, controller 72 may be configured to adjust the natural frequency of the subsea power transmission line toward the supply frequency for the AC electrical current that is conducted by the subsea power transmission line to decrease electrical losses within the subsea power distribution system.

FIG. 3 provides a less schematic but still illustrative, non-exclusive example of a portion of subsea power transmission line 55 according to the present disclosure. The portion of the subsea power transmission line shown in FIG. 3 is substantially similar to that shown in FIG. 2 except that FIG. 3 provides a more detailed, but still illustrative, non-exclusive example, of the electrical structure of impedance compensation device 65.

In FIG. 3, inductive coupling interface 70 provides electrical communication between subsea power transmission cable 60 and impedance compensation device 65 through the use of coupling inductor 71. Coupling interface 70 may generate an electric current in impedance compensation device 65, such as in coupling inductor 71, through interaction with electric fields generated by the flow of AC electric current through subsea power transmission cable 60.

Impedance compensation device 65 includes at least switching device 78 and impedance compensation element 80, and, as shown in dashed lines, may include a plurality of switching devices 78 and/or impedance compensation elements 80. Impedance compensation device 65 also may include controller 72, detector 74, and/or power supply 76. When impedance compensation device 65 includes controller 72, control linkage 82 may provide a communication link between controller 72 and switching device 78. As an illustrative, non-exclusive example, controller 72 may control the state of switching device 78 to control the electrical connection between impedance compensation element 80 and subsea power transmission cable 60.

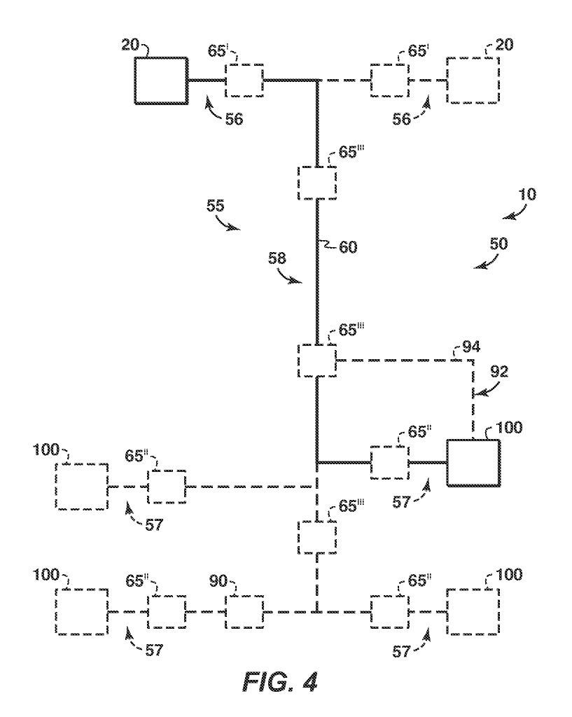

FIG. 4 provides a schematic representation of an illustrative, non-exclusive example of a power generating and distributing assembly 10, including electricity source 20 and subsea power distribution system 50, according to the present disclosure. Though shown in more schematic form, the power generating and distributing assembly and the subsea power distribution system of FIG. 4 are substantially similar to those shown in FIG. 1.

However, FIG. 4 schematically illustrates that it is within the scope of the present disclosure that subsea power distribution system 50 may receive and distribute electrical energy from a plurality of electricity sources 20. In addition, FIG. 4 also illustrates that impedance compensation devices 65 may be present at any suitable location within the subsea power distribution system, including proximal to the electricity source (or in power supply region 56 of the subsea power transmission line), as shown at 65′, proximal to energy consuming device 100 (or in power delivery region 57 of the subsea power transmission line), as shown at 65″, and/or in power transfer region 58 of the subsea power transmission line, as shown at 65′″. FIG. 4 also illustrates that subsea power distribution system 50 may provide electrical energy to any suitable number of energy consuming devices 100, and that subsea power distribution system 50 and/or subsea power transmission line 55 may include other suitable electrical components, such as transformer 90.

It is within the scope of the present disclosure that subsea power distribution system 50 may include one or more communication links 92 that are configured to provide electrical communication between one or more impedance compensation devices 65 included in the subsea power distribution system. Communication link 92 may be configured to transmit a data signal 94 between impedance compensation devices connected thereto. As an illustrative, non-exclusive example, subsea power distribution system 50 may include at least a first controller associated with a first impedance compensation device and a second controller associated with a second impedance compensation device, and communication link 92 may transmit information between the first controller and the second controller. As another illustrative, non-exclusive example, it is also within the scope of the present disclosure that the first controller and/or the second controller may be configured to control the operation of one or more of the impedance compensation devices associated therewith based at least in part on the information contained within the data signal. As yet another illustrative, non-exclusive example, it is within the scope of the present disclosure that a first portion of the impedance compensation devices may include a controller and that a second portion of the impedance compensation devices may not include a controller. Under these conditions, a controller associated with the first portion of the impedance compensation devices may control the operation of one or more of the impedance compensation devices associated with the second portion of the impedance compensation devices using communication link 92.

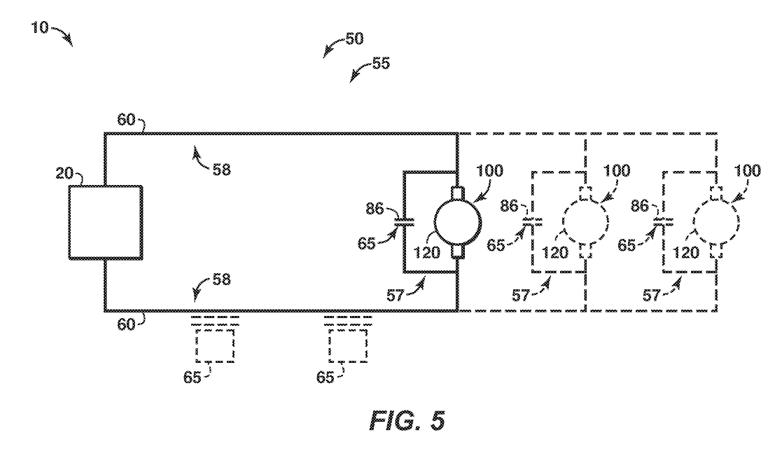

FIG. 5 provides yet another illustrative, non-exclusive example of a power generating and distributing assembly 10, including electricity source 20 and subsea power distribution system 50, according to the present disclosure. In FIG. 5, subsea power distribution system 50 supplies electrical energy from electricity source 20 to one or more energy consuming devices 100 that include electric motors 120. When the power generating and distribution assembly of FIG. 5 includes or is in electrical communication with a plurality of energy consuming devices 100, as shown in dashed lines, the plurality of energy consuming devices are electrically connected in parallel as shown. Each of the energy consuming devices of FIG. 5 includes a dedicated impedance compensation device 65, in the form of a capacitor 86, that is associated with power delivery region 57 of subsea power transmission line 55. In addition, and as shown in dashed lines, the subsea power distribution system of FIG. 5 also may include one or more impedance compensation devices 65 that are associated with power transfer region 58.

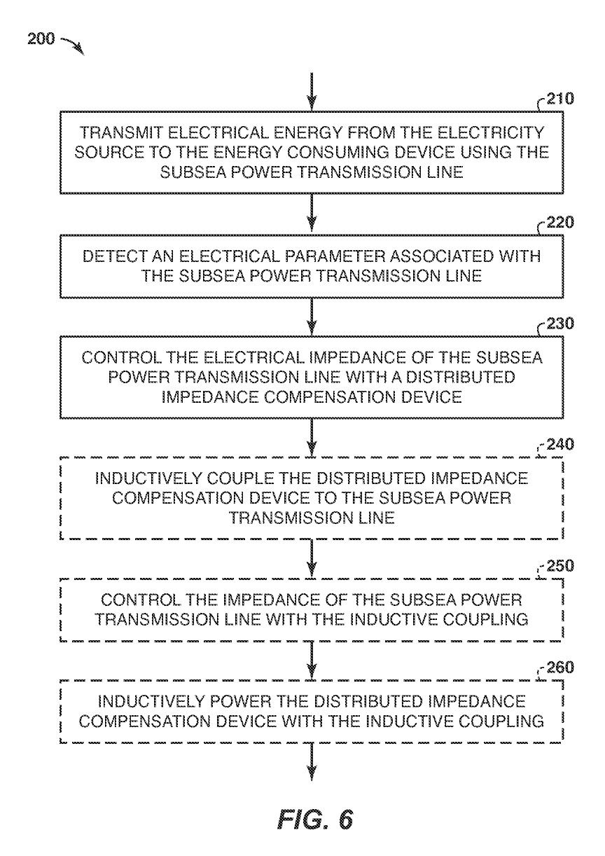

FIG. 6 is a flowchart depicting methods of controlling the transmission of electrical power 200 in a subsea power distribution system, such as the subsea power distribution systems 50 described herein, according to the present disclosure. The methods include transmitting electrical energy from the electricity source to the energy consuming device using the subsea power transmission line at 210, detecting an electrical parameter associated with the subsea power transmission line at 220, and controlling the electrical impedance of the subsea power transmission line with a distributed impedance compensation device based at least in part on the detected electrical parameter at 230. In addition, the methods also may optionally include inductively coupling one or more distributed impedance compensation devices to the subsea power transmission line at 240, controlling the impedance of the subsea power transmission line through the inductive coupling at 250, and/or inductively powering the distributed impedance compensation device with the inductive coupling at 260.

Transmitting electrical energy from the electricity source to the energy consuming device using the subsea power transmission line at 230 may include transmitting the electrical energy in any suitable fashion. As an illustrative, non-exclusive example, the method may include transmitting electrical energy from electricity source 20 to energy consuming device 100 using any of the power generating and distributing assemblies 10 and/or subsea power distribution systems 50 disclosed herein.

Detecting the electrical parameter associated with the subsea power transmission line at 220 may include detecting any suitable electrical parameter, including the electrical parameters discussed in more detail herein. This may include detecting any suitable voltage, electric current, electric power, electrical impedance, reactive power, real power, and/or apparent power associated with power generating and distributing assembly 10, electricity source 20, subsea power distribution system 50, subsea power transmission line 55, and/or subsea power transmission cable 60.

Controlling the electrical impedance of the subsea power transmission line with the distributed impedance compensation device based at least in part on the detected electrical parameter at 230 may include the use of any suitable structure associated with the distributed impedance compensation device to control the impedance of the subsea power transmission line. This may include the use of a distributed impedance compensation device that is associated with any suitable region, or portion, of the subsea power transmission line, as discussed in more detail herein. It is within the scope of the present disclosure that controlling the electrical impedance of the subsea power transmission line may include selectively and/or automatically controlling the electrical impedance of the subsea power transmission line. As an illustrative, non-exclusive example, and as discussed in more detail herein, this may include controlling the resistance, the inductance, and/or the capacitance of the subsea power transmission line.

It is within the scope of the present disclosure that the controlling may include controlling based at least in part on the detected electrical parameter and/or based at least in part on any suitable detected, measured, calculated, and/or provided parameter and/or value. This may include the use of any of the control strategies discussed in more detail herein with reference to FIG. 2.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, publications, or other references that are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

PCT1. A subsea power transmission line comprising:

a subsea power transmission cable; and

a plurality of distributed impedance compensation devices inductively coupled to the subsea power transmission cable.

PCT2. The subsea power transmission line of paragraph PCT1, wherein the plurality of distributed impedance compensation devices is inductively powered by the subsea power transmission cable.

PCT3. The subsea power transmission line of any of paragraphs PCT1-PCT2, wherein the plurality of distributed impedance compensation devices includes an impedance compensation element, and further wherein the impedance compensation element includes at least one of a resistor, an inductor, and a capacitor.

PCT4. The subsea power transmission line of any of paragraphs PCT1-PCT3, wherein the plurality of distributed impedance compensation devices includes a switching device, and further wherein the switching device is configured to selectively establish electrical communication between the impedance compensation element and the subsea power transmission cable responsive to an electrical parameter of the subsea power transmission line.

PCT5. The subsea power transmission line of paragraph PCT4, wherein the switching device includes at least one of a solid state switch, a transistor, an insulated gate bipolar transistor, a thyristor, a gate turn off thyristor, an integrated gate commutated thyristor, a metal oxide semiconductor field effect transistor, and a silicon controlled rectifier.

PCT6. The subsea power transmission line of any of paragraphs PCT1-PCT5, wherein the subsea power transmission line includes a power supply region, and further wherein a portion of the plurality of distributed impedance compensation devices is associated with the power supply region.

PCT7. The subsea power transmission line of any of paragraphs PCT1-PCT6, wherein the subsea power transmission line includes a power delivery region, and further wherein a portion of the plurality of distributed impedance compensation devices is associated with the power delivery region.

PCT8. The subsea power transmission line of any of paragraphs PCT1-PCT7, wherein the plurality of distributed impedance compensation devices is at least one of periodically and systematically distributed along a length of the subsea power transmission line.

PCT9. The subsea power transmission line of any of paragraphs PCT1-PCT8, wherein the subsea power transmission line is at least 1500 kilometers in length, and further wherein at least 99% of a length of the subsea power transmission line is located under water.

PCT10. The subsea power transmission line of any of paragraphs PCT1-PCT9, wherein the plurality of distributed impedance compensation devices is at least one of operatively attached to the subsea power transmission cable, integrated into the subsea power transmission cable, and a portion of the subsea power transmission cable.

PCT11. A system for controlling the electrical impedance of a subsea power transmission line, the system comprising:
the subsea power transmission line of paragraph PCT1; and
a controller configured to control the operation of a portion of the plurality of distributed impedance compensation devices.

PCT12. A system for controlling the electrical impedance of a subsea power transmission line, the system comprising:
the subsea power transmission line comprising:
a subsea power transmission cable; and
a plurality of distributed impedance compensation devices, wherein the plurality of distributed impedance compensation devices include marinised impedance compensation devices configured for use under water; and
a controller configured to control the operation of a portion of the plurality of distributed impedance compensation devices, wherein the controller is integrated into at least one of the portion of the plurality of distributed impedance compensation devices.

PCT13. A method for controlling the transmission of electrical power in a subsea power distribution system, the method comprising:
transmitting electrical energy from a power source to an energy consuming device with a subsea power transmission line, wherein the subsea power transmission line includes a subsea power transmission cable and a plurality of distributed impedance compensation devices;
detecting an electrical parameter associated with the subsea power transmission line with a detector; and
controlling an electrical impedance of the subsea power transmission line based at least in part on the detected electrical parameter, wherein the controlling includes controlling the operation of the plurality of distributed impedance compensation devices.

PCT14. The method of paragraph PCT13, wherein the method further includes inductively coupling the plurality of distributed impedance compensation devices to the subsea power transmission cable.

PCT15. The method of paragraph PCT13, wherein the controlling includes modifying the electrical impedance of the subsea power transmission line using the inductive coupling.

A1. A subsea power transmission line comprising:

a subsea power transmission cable; and

a plurality of distributed impedance compensation devices, wherein the plurality of distributed impedance compensation devices include marinised impedance compensation devices configured for use under water.

A2. The subsea power transmission line of paragraph A1, wherein the plurality of distributed impedance compensation devices is inductively coupled to the subsea power transmission cable, and optionally wherein the plurality of distributed impedance compensation devices is inductively powered by the subsea power transmission cable.

A3. The subsea power transmission line of paragraph A1 or A2, wherein the subsea power transmission cable includes a three-phase alternating current subsea power transmission cable, wherein the three-phase alternating current subsea power transmission cable includes at least three conductors, and further wherein each of the at least three conductors is electrically isolated from the other of the at least three conductors.

A4. The subsea power transmission line of paragraph A3, wherein each of the at least three conductors includes an insulating sheath.

A5. The subsea power transmission line of paragraph A3 or A4, wherein at least a portion of the at least three conductors is bundled together along at least a portion of a length of the subsea power transmission line.

A6. The subsea power transmission line of any of paragraphs A3-A5, wherein the plurality of distributed impedance compensation devices is inductively coupled to one of the at least three conductors.

A7. The subsea power transmission line of any of paragraphs A1-A6, wherein the plurality of distributed impedance compensation devices includes an impedance compensation element, and optionally wherein the plurality of distributed impedance compensation devices includes a plurality of impedance compensation elements.

A8. The subsea power transmission line of paragraph A7, wherein the impedance compensation element includes at least one of a resistor, an inductor, and a capacitor.

A9. The subsea power transmission line of any of paragraphs A7-A8, wherein the plurality of distributed impedance compensation devices includes a switching device, and optionally wherein the switching device is configured to selectively establish electrical communication between the impedance compensation element and the subsea power transmission cable responsive to an electrical parameter of the subsea power transmission line.

A10. The subsea power transmission line of paragraph A9, wherein the switching device includes at least one of a solid state switch, a transistor, an insulated gate bipolar transistor, a thyristor, a gate turn off thyristor, an integrated gate commutated thyristor, a metal oxide semiconductor field effect transistor, and a silicon controlled rectifier.

A11. The subsea power transmission line of any of paragraphs A1-A10, wherein the plurality of distributed impedance compensation devices includes a power supply configured to supply power to the distributed impedance compensation devices, and optionally wherein the power supply includes an alternating current to direct current converter.

A12. The subsea power transmission line of any of paragraphs A1-A11, wherein the subsea power transmission line includes a power supply region, and further wherein a portion of the plurality of distributed impedance compensation devices is associated with the power supply region.

A13. The subsea power transmission line of any of paragraphs A1-A12, wherein the subsea power transmission line includes a power delivery region, and further wherein a portion of the plurality of distributed impedance compensation devices is associated with the power delivery region.

A14. The subsea power transmission line of any of paragraphs A1-A13, wherein a portion of the plurality of distributed impedance compensation devices is distributed periodically along a length of the subsea power transmission line.

A15. The subsea power transmission line of any of paragraphs A1-A14, wherein a portion of the plurality of distributed impedance compensation devices is distributed systematically along a length of the subsea power transmission line.

A16. The subsea power transmission line of any of paragraphs A1-A15, wherein a location for at least a portion, and optionally all, of the plurality of distributed impedance compensation devices is selected based at least in part on at least one of a power of an electrical energy transmitted by the subsea power transmission line, a frequency of the electrical energy transmitted by the subsea power transmission line, a voltage of the electrical energy transmitted by the subsea power transmission line, a current of the electrical energy transmitted by the subsea power transmission line, an electrical impedance of the subsea power transmission line, an electrical impedance of a power source associated with the subsea power transmission line, an electrical impedance of an energy consuming device associated with the subsea power transmission line, a length of the subsea power transmission line, and a variable associated with the plurality of distributed impedance compensation devices.

A17. The subsea power transmission line of any of paragraphs A1-A16, wherein the subsea power transmission line is at least 100 kilometers (km) in length, optionally including subsea power transmission lines of at least 200 km, at least 300 km, at least 400 km, at least 500 km, at least 750 km, at least 1000 km, at least 1250 km, at least 1500 km, at least 2000 km, at least 2500 km, at least 3000 km, at least 4000 km, or at least 5000 km in length.

A18. The subsea power transmission line of any of paragraphs A1-A17, wherein at least 50% of a length of the subsea power transmission line is located under water, and optionally wherein at least 60%, at least 70%, at least 80%, at least 90%, at least 95%, at least 99%, at least 99.5%, or at least 99.9% of the length of the subsea power transmission line is located under water.

A19. The subsea power transmission line of any of paragraphs A1-A18, wherein the plurality of distributed impedance compensation devices is operatively attached to the subsea power transmission cable.

A20. The subsea power transmission line of any of paragraphs A1-A19, wherein the plurality of distributed impedance compensation devices at least one of forms a part of the subsea power transmission cable and is integrated into the subsea power transmission cable.

B1. A system for controlling the electrical impedance of a subsea power transmission line, the system comprising:

the subsea power transmission line of any of paragraphs A1-A20; and

a controller configured to control the operation of a portion of the plurality of distributed impedance compensation devices.

B2. The system of paragraph B1, wherein the controller is configured to control the operation of all of the plurality of distributed impedance compensation devices.

B3. The system of any of paragraphs B1-B2, wherein the controller is integrated into the portion of the plurality of distributed impedance compensation devices.

B4. The system of any of paragraphs B1-B3, wherein the controller is inductively powered by the subsea power transmission cable.

B5. The system of any of paragraphs B1-B4, wherein the controller is configured to selectively control an electrical impedance of the subsea power transmission line, optionally wherein the controller controls the electrical impedance of the subsea power transmission line by controlling at least one of the resistance, the inductance, and the capacitance of the subsea power transmission line, optionally wherein the controller controls the electrical impedance of the subsea power transmission line by controlling the operation of the portion of the plurality of distributed impedance compensation devices, and further optionally wherein the controller controls the electrical impedance of the subsea power transmission line automatically.

B6. The system of any of paragraphs B1-B5, wherein the system further includes a detector associated with the portion of the plurality of distributed impedance compensation devices.

B7. The system of paragraph B6, wherein the detector is configured to detect an electrical parameter of the subsea power transmission line, and optionally wherein the detector is configured to detect an electrical parameter associated with at least one conductor of the subsea power transmission line.

B8. The system of paragraph B7, wherein the electrical parameter of the subsea power transmission line includes at least one of an electrical voltage associated with the subsea power transmission line, an electrical current associated with the subsea power transmission line, an electrical power associated with the subsea power transmission line, an electrical impedance associated with the subsea power transmission line, a reactive power associated with the subsea power transmission line, and a real power associated with the subsea power transmission line.

B9. The system of any of paragraphs B1-B8, wherein the controller is configured to increase a capacitance of the subsea power transmission line responsive to an increase in an electrical current conducted by the subsea power transmission line.

B10. The system of any of paragraphs B1-B9, wherein the controller is configured to decrease a capacitance of the subsea power transmission line responsive to a decrease in an electrical current conducted by the subsea power transmission line.

B11. The system of any of paragraphs B1-B10, wherein the controller is configured to increase an inductance of the subsea power transmission line responsive to an increase in a capacitance of the subsea power transmission line.

B12. The system of any of paragraphs B1-B11, wherein the controller is configured to decrease an inductance of the subsea power transmission line responsive to a decrease in a capacitance of the subsea power transmission line.

B13. The system of any of paragraphs B1-B12, wherein the controller is configured to protect electrical equipment associated with the system from short circuits.

B14. The system of any of paragraphs B1-B13, wherein the controller is configured to adjust a natural frequency of the subsea power transmission line away from a supply frequency of an electrical current conducted by the subsea power transmission line.

B15. The system of any of paragraphs B1-B14, wherein the controller is a first controller configured to control the operation of a first portion of the plurality of distributed impedance compensation devices, and further wherein the system includes a second controller configured to control the operation of a second portion of the plurality of distributed impedance compensation devices.

B16. The system of paragraph B15, wherein the system further includes a communication link configured to transmit a data signal between the first controller and the second controller, and optionally wherein at least one of the first controller and the second controller is configured to control the operation of at least one of the first portion of the plurality of distributed impedance compensation devices and the second portion of the plurality of distributed impedance compensation devices responsive to the data signal.

C1. An apparatus for controlling the transmission of electrical power in a subsea environment, the apparatus comprising:

a source of alternating current electrical power;

the system of any of paragraphs B1-B16; and

an energy consuming device.

C2. The apparatus of paragraph C1, wherein the source of alternating current electrical power includes at least one of an electrical power grid and an electrical generator.

C3. The apparatus of any of paragraphs C1-C2, wherein the energy consuming device includes an electric motor, optionally wherein the electric motor includes a three phase alternating current electric motor, and further optionally wherein the electric motor is configured to power at least one of a pump and a compressor.

C4. The apparatus of any of paragraphs C1-C3, wherein the energy consuming device includes a subsea energy consuming device.

C5. The apparatus of any of paragraphs C1-C4, wherein the apparatus is configured to supply electrical power to at least one of subsea hydrocarbon recovery equipment, a subsea oil well, a subsea oil pressure booster pump, a subsea natural gas compressor, subsea oil well monitoring equipment, and subsea oil pipeline heating equipment.

D1. A method for controlling the transmission of electrical power in a subsea power distribution system, the method comprising:
transmitting electrical energy from a power source to an energy consuming device with a subsea power transmission line, wherein the subsea power transmission line includes a subsea power transmission cable and a plurality of distributed impedance compensation devices;

detecting an electrical parameter associated with the subsea power transmission line with a detector; and
controlling an electrical impedance of the subsea power transmission line based at least in part on the detected electrical parameter, wherein the controlling includes controlling the operation of the plurality of distributed impedance compensation devices.

D2. The method of paragraph D1, wherein the method further includes inductively coupling the plurality of distributed impedance compensation devices to the subsea power transmission cable.

D3. The method of paragraph D2, wherein the inductively coupling includes inductively powering the plurality of distributed impedance compensation devices with power obtained from the subsea power transmission cable.

D4. The method of any of paragraphs D2-D3, wherein the controlling includes modifying the electrical impedance of the subsea power transmission line using the inductive coupling.

D5. The method of any of paragraphs D1-D4, wherein the subsea power transmission line includes a power supply region, wherein a portion of the plurality of distributed impedance compensation devices is associated with the power supply region, and further wherein the controlling includes controlling the electrical impedance of the subsea power transmission line by controlling the operation of at least a fraction of the portion of the plurality of distributed impedance compensation devices associated with the power supply region.

D6. The method of any of paragraphs D1-D5, wherein the subsea power transmission line includes a power delivery region, wherein a portion of the plurality of distributed impedance compensation devices is associated with the power delivery region, and further wherein the controlling includes controlling the electrical impedance of the subsea power transmission line by controlling the operation of at least a fraction of the portion of the plurality of distributed impedance compensation devices associated with the power delivery region.

D7. The method of any of paragraphs D1-D6, wherein a portion of the plurality of distributed impedance compensation devices is distributed along a length of the subsea power transmission line, and further wherein the controlling includes controlling the electrical impedance of the subsea power transmission line by controlling the operation of at least a fraction of the portion of the plurality of distributed impedance compensation devices distributed along the length of the subsea power transmission line.

D8. The method of any of paragraphs D1-D7, wherein the controlling includes selectively controlling the electrical impedance of the subsea power transmission line, optionally wherein the controlling includes controlling at least one of the resistance, the inductance, and the capacitance of the subsea power transmission line, and further optionally wherein the controlling includes automatically controlling the electrical impedance of the subsea power transmission line.

D9. The method of any of paragraphs D1-D8, wherein the electrical parameter of the subsea power transmission line includes at least one of an electrical voltage associated with the subsea power transmission line, an electrical current associated with the subsea power transmission line, an electrical power associated with the subsea power transmission line, an electrical impedance associated with the subsea power transmission line, a reactive power associated with the subsea power transmission line, and a real power associated with the subsea power transmission line.

D10. The method of paragraph D9, wherein the controlling includes controlling based at least in part on the detected electrical parameter of the subsea power transmission line.

D11. The method of paragraph D10, wherein the controlling includes increasing a capacitance of the subsea power transmission line responsive to an increase in an electrical current conducted by the subsea power transmission line.

D12. The method of any of paragraphs D10-D11, wherein the controlling includes decreasing a capacitance of the subsea power transmission line responsive to a decrease in an electrical current conducted by the subsea power transmission line.

D13. The method of any of paragraphs D10-D12, wherein the controlling includes increasing an inductance of the subsea power transmission line responsive to an increase in a capacitance of the subsea power transmission line.

D14. The method of any of paragraphs D10-D13, wherein the controlling includes decreasing an inductance of the subsea power transmission line responsive to a decrease in a capacitance of the subsea power transmission line.

D15. The method of any of paragraphs D1-D14, wherein the controlling includes protecting electrical equipment associated with the subsea power distribution system from short circuits.

D16. The method of any of paragraphs D1-D15, wherein the controlling includes controlling the electrical impedance of the subsea power transmission line to adjust a natural frequency of the subsea power transmission line away from a supply frequency of an electrical current conducted by the subsea power transmission line.

D17. The method of any of paragraphs D1-D16, wherein the subsea power transmission line includes the subsea power transmission line of any of paragraphs A1-A20.

D18. The method of any of paragraphs D1-D16, wherein the method is performed using the system of any of paragraphs B1-B16.

D19. The method of any of paragraphs D1-D18, wherein the method is performed using the apparatus of any of paragraphs C1-C5.

E1. The use of any of the systems of any of paragraphs A1-C5 with any of the methods of any of paragraphs D1-D19.

E2. The use of any of the methods of any of paragraphs D1-D19 with any of the systems of any of paragraphs C1-C5.

E3. The use of any of the systems of any of paragraphs A1-C5 or any of the methods of any of paragraphs D1-D19 to produce hydrocarbons.

E4. The use of any of the systems of any of paragraphs A1-C5 or any of the methods of any of paragraphs D1-D19 to transmit electrical energy in a subsea environment.

E5. The use of any of the systems of any of paragraphs A1-C5 or any of the methods of any of paragraphs D1-D19 to control an electrical impedance, and optionally to automatically control the electrical impedance, of a subsea power transmission line.

E6. The use of any of the systems of any of paragraphs A1-C5 or any of the methods of any of paragraphs D1-D19 to control a reactive power, and optionally to automatically control the reactive power, associated with a subsea power transmission line.

### INDUSTRIAL APPLICABILITY

The systems and methods disclosed herein are applicable to the oil and gas industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A subsea power transmission line comprising:
a subsea power transmission cable; and
a plurality of distributed impedance compensation devices inductively coupled to the subsea power transmission cable.

2. The subsea power transmission line of claim 1, wherein the plurality of distributed impedance compensation devices is inductively powered by the subsea power transmission cable.

3. The subsea power transmission line of claim 1, wherein the plurality of distributed impedance compensation devices includes an impedance compensation element, and further wherein the impedance compensation element includes at least one of a resistor, an inductor, and a capacitor.

4. The subsea power transmission line of claim 1, wherein the plurality of distributed impedance compensation devices includes a switching device, and further wherein the switching device is configured to selectively establish electrical communication between the impedance compensation element and the subsea power transmission cable responsive to an electrical parameter of the subsea power transmission line.

5. The subsea power transmission line of claim 4, wherein the switching device includes at least one of a solid state switch, a transistor, an insulated gate bipolar transistor, a thyristor, a gate turn off thyristor, an integrated gate commutated thyristor, a metal oxide semiconductor field effect transistor, and a silicon controlled rectifier.

6. The subsea power transmission line of claim 1, wherein the subsea power transmission line includes a power supply region, and further wherein a portion of the plurality of distributed impedance compensation devices is associated with the power supply region.

7. The subsea power transmission line of claim 1, wherein the subsea power transmission line includes a power delivery region, and further wherein a portion of the plurality of distributed impedance compensation devices is associated with the power delivery region.

8. The subsea power transmission line of claim 1, wherein the plurality of distributed impedance compensation devices is at least one of periodically and systematically distributed along a length of the subsea power transmission line.

9. The subsea power transmission line of claim 1, wherein the subsea power transmission line is at least 1500 kilometers in length, and further wherein at least 99% of a length of the subsea power transmission line is located under water.

10. The subsea power transmission line of claim 1, wherein the plurality of distributed impedance compensation devices is at least one of operatively attached to the subsea power transmission cable, integrated into the subsea power transmission cable, and a portion of the subsea power transmission cable.

11. A system for controlling the electrical impedance of a subsea power transmission line, the system comprising:
the subsea power transmission line of claim 1; and
a controller configured to control the operation of a portion of the plurality of distributed impedance compensation devices.

12. The system of claim 11, wherein the controller is integrated into at least one of the portion of the plurality of distributed impedance compensation devices.

13. The system of claim 11, wherein the controller is configured to selectively control an electrical impedance of the subsea power transmission line, and further wherein the controller controls the electrical impedance of the subsea power transmission line automatically.

14. The system of claim 13, wherein the controller is configured to adjust a natural frequency of the subsea power transmission line away from a supply frequency of an electrical current conducted by the subsea power transmission line.

15. The system of claim 11, wherein the system further includes a detector associated with the portion of the plurality of distributed impedance compensation devices, wherein the detector is configured to detect an electrical parameter of the subsea power transmission line, and further wherein the electrical parameter of the subsea power transmission line includes at least one of an electrical voltage associated with the subsea power transmission line, an electrical current associated with the subsea power transmission line, an electrical power associated with the subsea power transmission line, an electrical impedance associated with the subsea power transmission line, a reactive power associated with the subsea power transmission line, and a real power associated with the subsea power transmission line.

16. The system of claim 11, wherein the controller is configured to increase a capacitance of the subsea power transmission line responsive to an increase in an electrical current conducted by the subsea power transmission line, and further wherein the controller is configured to decrease a capacitance of the subsea power transmission line responsive to a decrease in an electrical current conducted by the subsea power transmission line.

17. The system of claim 11, wherein the controller is configured to increase an inductance of the subsea power transmission line responsive to an increase in a capacitance of the subsea power transmission line, and further wherein the controller is configured to decrease an inductance of the subsea power transmission line responsive to a decrease in a capacitance of the subsea power transmission line.

18. An apparatus for controlling the transmission of electrical power in a subsea environment, the apparatus comprising:
a source of alternating current electrical power;
the system of claim 11; and
an energy consuming device.

19. The apparatus of claim 18, wherein the energy consuming device includes at least one of subsea hydrocarbon recovery equipment, a subsea oil well, a subsea oil pressure booster pump, a subsea natural gas compressor, subsea oil well monitoring equipment, and subsea oil pipeline heating equipment.

20. A system for controlling the electrical impedance of a subsea power transmission line, the system comprising:
the subsea power transmission line comprising:
a subsea power transmission cable; and
a plurality of distributed impedance compensation devices, wherein the plurality of distributed impedance compensation devices include marinised impedance compensation devices configured for use under water; and
a controller configured to control the operation of a portion of the plurality of distributed impedance compensation devices, wherein the controller is integrated into at least one of the portion of the plurality of distributed impedance compensation devices.

21. The system of claim 20, wherein the controller is configured to selectively control the electrical impedance of the subsea power transmission line, and further wherein the controller controls the electrical impedance of the subsea power transmission line automatically.

22. The system of claim 20, wherein the controller is configured to adjust a natural frequency of the subsea power transmission line away from a supply frequency of an electrical current conducted by the subsea power transmission line.

23. The system of claim 20, wherein the controller is configured to increase a capacitance of the subsea power transmission line responsive to an increase in an electrical current conducted by the subsea power transmission line, and further wherein the controller is configured to decrease a capacitance of the subsea power transmission line responsive to a decrease in an electrical current conducted by the subsea power transmission line.

24. A method for controlling the transmission of electrical power in a subsea power distribution system, the method comprising:
transmitting electrical energy from a power source to an energy consuming device with a subsea power transmission line, wherein the subsea power transmission line includes a subsea power transmission cable and a plurality of distributed impedance compensation devices;
detecting an electrical parameter associated with the subsea power transmission line with a detector; and
controlling an electrical impedance of the subsea power transmission line based at least in part on the detected electrical parameter, wherein the controlling includes controlling the operation of the plurality of distributed impedance compensation devices.

25. The method of claim 24, wherein the method further includes inductively coupling the plurality of distributed impedance compensation devices to the subsea power transmission cable.

26. The method of claim 25, wherein the inductively coupling includes inductively powering the plurality of distributed impedance compensation devices with power obtained from the subsea power transmission cable.

27. The method of claim 25, wherein the controlling includes modifying the electrical impedance of the subsea power transmission line using the inductive coupling.

28. The method of claim 24, wherein the subsea power transmission line includes a power supply region, wherein a portion of the plurality of distributed impedance compensation devices is associated with the power supply region, and further wherein the controlling includes controlling the electrical impedance of the subsea power transmission line by controlling the operation of at least a fraction of the portion of the plurality of distributed impedance compensation devices associated with the power supply region.

29. The method of claim 24, wherein the subsea power transmission line includes a power delivery region, wherein a portion of the plurality of distributed impedance compensation devices is associated with the power delivery region, and further wherein the controlling includes controlling the electrical impedance of the subsea power transmission line by controlling the operation of at least a fraction of the portion of the plurality of distributed impedance compensation devices associated with the power delivery region.

30. The method of claim 24, wherein a portion of the plurality of distributed impedance compensation devices is distributed along a length of the subsea power transmission line, and further wherein the controlling includes controlling the electrical impedance of the subsea power transmission line by controlling the operation of at least a fraction of the portion of the plurality of distributed impedance compensation devices distributed along the length of the subsea power transmission line.
